(19) United States
(12) Patent Application Publication
(10) Pub. No.: US 2015/0362938 A1
(43) Pub. Date: Dec. 17, 2015

(54) HVAC COUPLED BATTERY STORAGE SYSTEM

(71) Applicant: Carrier Corporation, Farmington, CT (US)

(72) Inventor: Daniel J. Dempsey, Carmel, IN (US)

(21) Appl. No.: 14/733,122

(22) Filed: Jun. 8, 2015

Related U.S. Application Data
(60) Provisional application No. 62/012,778, filed on Jun. 16, 2014.

(51) Int. Cl. G05F 1/66; G06Q 20/14

(52) U.S. Cl. CPC G05F 1/66; G06Q 20/14

(57) ABSTRACT

A method for operating an HVAC system including a power module operably coupled to a controller, an outdoor unit assembly, and a plurality of power sources is provided. The method includes the steps of operating the controller to receive a utility pricing rate; and operating the controller to compare the utility pricing rate with at least one pricing parameter. Which of the plurality of power sources to operate based at least in part on the at least one pricing parameter and utility pricing rate is determined. The power module is operated to supply power to the outdoor unit assembly based on the power source chosen.

### CROSS REFERENCE TO RELATED APPLICATIONS

The present application is related to, and claims the priority benefit of, U.S. Provisional Patent Application Ser. No. 62/012,778 filed Jun. 16, 2014, the contents of which are hereby incorporated in their entirety into the present disclosure.

### TECHNICAL FIELD OF THE DISCLOSED EMBODIMENTS

The presently disclosed embodiments generally relate to heating, ventilation, and air-conditioning (HVAC) systems, and more particularly, to a battery system for use with an HVAC system.

### BACKGROUND OF THE DISCLOSED EMBODIMENTS

The implementation of “time of day” (ToD) electricity pricing is expected to grow in the residential market. As a result, there will be increasing demand for products and systems that can minimize energy use during peak demand periods. A need remains for the capability to store power from the electrical grid for later use during peak demand periods so as to reduce HVAC system capacity and energy use.

### SUMMARY OF THE DISCLOSED EMBODIMENTS

In at least one embodiment, a method for operating an HVAC system including a power module operably coupled to a controller, an outdoor unit assembly, and a plurality of power sources is provided. The method includes the steps of operating the controller to receive a utility pricing rate; and operating the controller to compare the utility pricing rate with at least one pricing parameter. Which of the plurality of power sources to operate based at least in part on the at least one pricing parameter and utility pricing rate is determined. The power module is operated to supply power to the outdoor unit assembly based on the power source chosen.

In at least one embodiment, an HVAC system is provided including a controller and a power module operably coupled to the controller. An outdoor unit assembly is operably coupled to the power module. A plurality of power sources is operably coupled to the power module. The controller is configured to operate the power module based at least in part on at least one pricing parameter.

In at least one embodiment, a method for operating an HVAC system is provided. The method includes the step of entering electrical pricing input into a control panel of the HVAC system. A first level of electrical pricing is cheaper than a second level of electrical pricing. The HVAC system is powered from an electrical grid when the electrical pricing is at the first level. The electrical power from the electrical grid is stored in a battery when the electrical pricing is at the first level. The HVAC system is powered from the battery when the electrical pricing is at the second level.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic view of an HVAC system formed in accordance with at least one embodiment.

FIG. 2 illustrates a method for operating an HVAC system.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

Three technologies are currently being used, or under development, to reduce the impact of time of day energy costs: 1) thermal storage of a chilled or cold medium, which is stored during low price periods then utilized during peak demand periods; 2) use of solar photovoltaic panels to augment air conditioning energy use during peak periods; and 3) adjustment of space temperature so as to reduce HVAC system capacity and energy use.

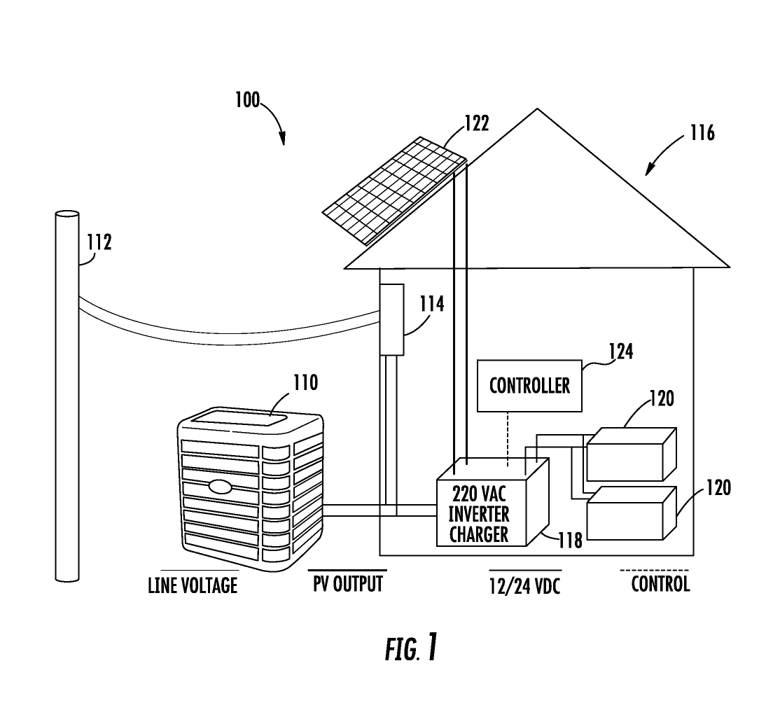

FIG. 1 illustrates an HVAC system 100 including an outdoor unit assembly 110 that is electrically coupled to an electrical grid 112 through an electrical box 114 of a structure 116. The electrical grid 112 supplies power to the outdoor unit assembly 110 so that the outdoor unit assembly 110 can circulate a refrigerant in order to facilitate conditioning air within the structure 116. The outdoor unit assembly 110 and the electrical grid 112 are further in electrical communication with a power module 118. In one embodiment, the power module is an inverter/charger. The power module 118 receives power from the electrical grid 112 so as to charge the at least one battery 120. In one embodiment, at least one solar panel 122 further supplies power to the power module 118. In other embodiments, additional non-grid energy sources, for example wind energy, heat, geothermal energy, hydraulic energy, or the like, may further supply power to the power module 118. Converted power from the at least one solar panel 122 may be directed to provide power to the outdoor unit assembly 110 and/or may directed to be stored in the batteries 120. Accordingly, the outdoor unit assembly 110 may be powered by any one of the electrical grid 112, the batteries 120, and/or the at least one solar panel 122. A controller 124, operably coupled to the power module 118, is configured to determine which power source supplies power to the outdoor unit assembly 110. Although the present disclosure is described with respect to an outdoor unit assembly 110, the method described below may be suitable for any appliance and/or electrical system used within the structure 116. For example, the method described below may be utilized with a lighting system (not shown), or an indoor unit assembly (not shown) of the structure 116 to name a couple of non-limiting examples.

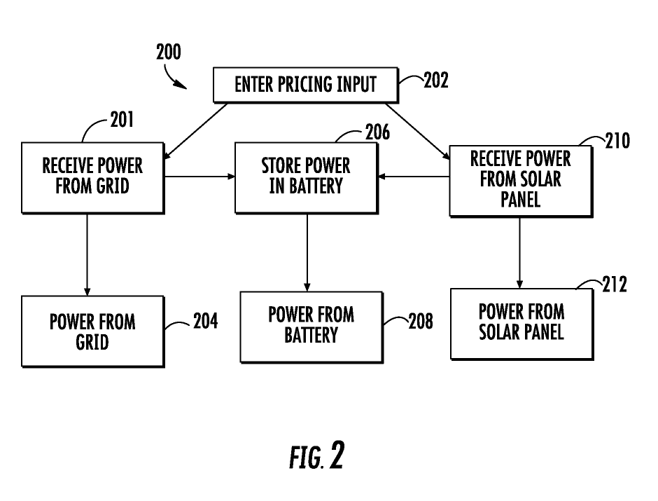

FIG. 2 illustrates a method 200 for utilizing the system 100. The method 200 includes entering electrical pricing input into the controller 124, at step 202. In one embodiment, the electrical pricing input is entered into the controller manually. Alternatively, the electrical pricing input may be automatically retrieved via a network. For example, the electrical pricing input may be retrieved from a “cloud” or via a utility website that tracks pricing. The electrical pricing input may be retrieved periodically or in real time. The electrical pricing input may be indicative of electricity demand, electricity cost, predicted electricity demand, predicted electricity cost, electricity requests from a utility, and time of day electricity costs. For example, with respect to time of day pricing, the price of the electricity from the electrical grid 112 may increase during peak demand times, as established by the local electrical utility entity. Electrical power is received from the electrical grid 112, at step 201. The outdoor unit assembly 110 is powered from the electrical grid 112, at step 204, when the electrical pricing is at a first level. Additionally, electrical power from the electrical grid 112 is stored in at least one battery 120, at step 206, when the electrical pricing is at the first level. When storing the electricity from the electrical grid 112, the electricity received from the electrical grid 112 is directed through the power module 118 prior to storing the electricity in the battery 120. When the electrical pricing is at a second level that is more expensive than the first level, the HVAC system is powered from the battery, at step 208. In particular, the electrical power in the battery 120 is relayed through the power module 118 to power the outdoor unit assembly 110.

In at least one embodiment, the system 100 includes the solar panel 122 and the method 200 includes receiving electricity from the solar panel 122, at step 210. In at least one embodiment, the electricity provided by the at least one solar panel 122 is stored in the at least one battery 120, at step 206. Alternatively, the solar power may be used to power the outdoor unit assembly 110, at step 212. For example, the solar power may be stored and/or used to power outdoor unit assembly 110, when the electrical pricing is at the first level. When the electrical pricing is at the second more expensive level, the solar power and/or the power stored in the battery 120 may be used to power the outdoor unit assembly 110.

It will therefore be appreciated that the disclosed embodiments provide a method for reducing the operating cost associated with powering an HVAC component when the price of electricity increases during a peak demand period.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A method for operating an HVAC system including a power module operably coupled to a controller, an outdoor unit assembly, and a plurality of power sources, the method comprising the steps:
operating the controller to receive a utility pricing rate;
operating the controller to compare the utility pricing rate with at least one pricing parameter;
determining which of the plurality of power sources to operate based at least in part on the at least one pricing parameter and utility pricing rate;
operating the power module to supply power to the outdoor unit assembly based on the power source chosen.

2. The method of claim 1, wherein the utility pricing rate is indicative of at least one of electricity demand, electricity cost, predicted electricity demand, predicted electricity cost, electricity requests from a utility, or time of day electricity costs.

3. The method of claim 1, wherein operating the controller to receive a utility pricing rate further comprises at least one of receiving the utility pricing rate via a network or entering the utility pricing rate manually.

4. The method of claim 1 further comprising relaying the electricity received from an electrical grid through the power module to charge a battery.

5. The method of claim 4 further comprising relaying the electrical power in the battery through the power module to provide electricity to the HVAC system.

6. The method of claim 1 further comprising receiving electricity from at least one of a solar panel, a wind turbine, a hydraulic turbine, heat, or geothermal energy.

7. The method claim 6 further comprising charging a battery with the electricity from the at least one of a solar panel, a wind turbine, a hydraulic turbine, heat, or geothermal energy.

8. The method of claim 6 further comprising providing electricity to the HVAC system from the at least one of a solar panel, a wind turbine, a hydraulic turbine, heat, or geothermal energy.

9. An HVAC system comprising:
a controller;
a power module operably coupled to the controller;
an outdoor unit assembly operably coupled to the power module; and;
a plurality of power sources operably coupled to the power module,
wherein the controller is configured to operate the power module based at least in part on at least one pricing parameter.

10. The HVAC system of claim 9, wherein the at least one pricing parameter is indicative of at least one of electricity demand, electricity cost, predicted electricity demand, predicted electricity cost, electricity requests from a utility, or time of day electricity costs.

11. The HVAC system of claim 9, wherein the at least one pricing parameter is retrieved by at least one of receiving the at least one pricing parameter via a network or entering the at least one pricing parameter manually.

12. The HVAC system of claim 9, wherein at least one of the plurality of power sources comprises at least one of a battery, a solar panel, a wind turbine, a hydraulic turbine, heat, or geothermal energy.

13. The HVAC system of claim 9, wherein at least one of the plurality of power sources comprises a connection to an electrical grid.

14. A method for operating an HVAC system comprises:
entering electrical pricing input into a control panel of the HVAC system, wherein a first level of electrical pricing is cheaper than a second level of electrical pricing;
powering the HVAC system from an electrical grid when the electrical pricing is at the first level;
storing electrical power from the electrical grid in a battery when the electrical pricing is at the first level; and
powering the HVAC system from the battery when the electrical pricing is at the second level.

15. The method of claim 14, wherein the electrical pricing input is indicative of at least one of electricity demand, electricity cost, predicted electricity demand, predicted electricity cost, electricity requests from a utility, or time of day electricity costs.

16. The method of claim 14, wherein entering electrical pricing input further comprises at least one of receiving the electrical pricing input via a network or entering the electrical pricing input manually.

17. The method of claim 14 further comprising
relaying the electricity received from the electrical grid through power module to store the electrical power in the battery when the electrical pricing is at the first level; and
relaying the electrical power in the battery through the power module to power the HVAC system when the electrical pricing is at the second level.

18. The method of claim 14 further comprising receiving electricity from at least one of a solar panel, a wind turbine, a hydraulic turbine, heat, or geothermal energy.

19. The method of claim 18 further comprising storing the electricity from at least one of a solar panel, a wind turbine, a hydraulic turbine, heat, or geothermal energy in the battery.

20. The method of claim 19 further comprising powering the HVAC system with the electricity from at least one of a solar panel, a wind turbine, a hydraulic turbine, heat, or geothermal energy.
